(19) United States
(12) Patent Application Publication
(10) Pub. No.: US 2006/0061004 A1
(43) Pub. Date: Mar. 23, 2006

(54) Extrusion process and decorative synthetic lumber produced therefrom

(75) Inventors: William A. Bufton, Watervliet, MI (US); Brent L. Coghill, Paw Paw, MI (US); Bert E. Corliss IV, Bridgeman, MI (US); Charles E. Croneworth, St. Clair, MI (US); Steven W. Henley, Berrien Springs, MI (US); Matthew E. Sexton, Hartford, MI (US)

Correspondence Address: WILLIAM J. SCHRAMM, P. O. BOX 4390, TROY, MI, 48099-4390, US

(73) Assignee: Green Tree Composites, LLC

(21) Appl. No.: 10/946,959

(22) Filed: Sep. 22, 2004

(51) Int. Cl. B29C 47/00

(52) U.S. Cl. 264/75

(57) ABSTRACT

Described is an extrusion process and a decorative synthetic lumber produced therefrom by providing a cellulose plastic composition; delivering the composition through an area containing a screw in an extruder; maintaining a back pressure in the screw area to keep the screw area filled with the composition; and extruding the composition, at a temperature at or slightly above the melt point of the composition, into a decorative shaped synthetic lumber product through a breaker plate designed to maintain the back pressure in the screw area. A colorant may be added to the feed throat of the extruder.

### FIELD OF THE INVENTION

The present invention is concerned with a decorative synthetic lumber composite extruded from a cellulose plastic composition.

### BACKGROUND OF THE INVENTION

In the field of synthetic lumber composites, it is desirable that the final product have a highly decorative finish. In particular, it is desirable that the synthetic lumber composite substantially resemble natural wood that may be cut from a felled tree.

U.S. Pat. No. 6,780,359 entitled “Synthetic Wood Composite Material and Method for Molding” describes a cellulosic reinforced plastic composite wherein during the manufacturing process, irregular shaped granules of the cellulosic reinforced plastic composite are prepared by grinding the granules to achieve an irregular shape prior to the final extrusion step.

U.S. Pat. No. 6,352,784 describes a decorative wood material coated with a resin composite film forming a laminate.

### BRIEF SUMMARY OF THE INVENTION

Described is a process for extruding a decorative synthetic lumber composite comprising; providing a cellulose plastic composition; delivering the composition through an area containing a screw in an extruder; maintaining a back pressure in the screw area to keep the screw area filled with the composition; and extruding the composition, at a temperature at or slightly above the melt point of the composition, into a decorative shaped synthetic lumber product through a breaker plate designed to maintain the back pressure in the screw area.

Another embodiment of the invention is a process for extruding a decorative synthetic lumber composite comprising providing a cellulose plastic composition; delivering the composition through an area containing a screw to an extruder; maintaining a back pressure in the screw area to keep the screw area filled with the composition; and extruding the composition, at a temperature of at or slightly above the melt point of the composition, into a decorative shaped synthetic lumber product through a breaker plate designed to maintain the back pressure in the screw area wherein a colorant is added to the composition at the feed throat of the extruder before it passes through the breaker plate so as to allow a portion of the colorant to remain on the surface of the extruded product thereby increasing the decorative properties of the extruded product.

Another embodiment of the invention is a process for extruding a decorative synthetic lumber composite comprising providing a cellulose plastic composition, delivering the composition through an area containing a screw to a first extruder; extruding pellets of the composition from the extruder; delivering the pellets through a heated area containing a screw to a second extruder; adding a colorant to the composition at the feed throat of the second extruder; maintaining a back pressure in the screw area of the second extruder to keep the screw area filled with the heated composition; and extruding the composition at a temperature at or slightly above the melt point of the composition into a decorative shaped synthetic lumber product through a breaker plate designed to maintain the back pressure in the screw area.

Another embodiment of the invention is a synthetic lumber composite produced according to the process for extruding a decorative synthetic lumber composite comprising providing a cellulose plastic composition; delivering the composition through an area containing a screw in an extruder; maintaining a back pressure in the screw area to keep the screw area filled with the composition; and extruding the composition, at a temperature of at or slightly above the melt point of the composition, into a decorative shaped synthetic lumber product through a breaker plate designed to maintain the back pressure in the screw area.

Another embodiment of the invention is a synthetic lumber composite produced for extruding a decorative synthetic lumber composite comprising providing a cellulose plastic composition; delivering the composition through an area containing a screw to an extruder; maintaining a back pressure in the screw area to keep the screw area filled with the composition; and extruding the composition, at a temperature of at or slightly above the melt point of the composition, into a decorative shaped synthetic lumber product through a breaker plate designed to maintain the back pressure in the screw area wherein a colorant is added at the feed throat of the extruder before the composition passes through the breaker plate so as to allow a portion of the colorant to remain on the surface of the extruded product thereby increasing the decorative properties of the extruded product.

It is an object of the present invention to be able to produce a synthetic cellulosic lumber product with improved highly decorative lumber resembling properties, preferably produced using low melt temperatures and pressures during the processing conditions.

### BRIEF DESCRIPTION OF THE SEVERAL VIEWS OF THE DRAWING

These and other objects, features and advantages of the present invention be apparent from the following detailed description of the preferred embodiments and best mode, appended claims and accompanying drawings in which:

FIG. 1 is a schematic sectional diagram of an apparatus for producing an extruded decorative synthetic lumber composite of the present invention;

FIG. 2 is a schematic representation of an apparatus for extruding a decorative synthetic lumber composite without the die for the extrusion attached thereto but with the breaker plate shown;

FIG. 3 is an end segment of an apparatus for extruding a decorative synthetic lumber composite showing the extruder die;

FIG. 4 is one embodiment of the breaker plate utilized in the extruder of the present invention;

FIG. 5 is a side view of FIG. 4;

FIG. 6 is another embodiment of the breaker plate of the present invention;

FIG. 7 is another embodiment of the breaker plate of the present invention;

FIG. 8 is another embodiment of the breaker plate of the present invention; and

FIG. 9 is another embodiment of the breaker plate of the present invention.

FIG. 10 is a side view of the embossing of the synthetic lumber of the present invention.

FIG. 11 is a photomicrograph of a perspective view of a cut product of the present invention showing the cut side and the top finished surface.

FIG. 12 is an exploded view of FIG. 11.

### DETAILED DESCRIPTION OF THE INVENTION

The invention as described herein takes into account the drawings as further included therein. These and other objects, advantages and features of the invention will become apparent to those skilled in the art upon consideration of the following description of the invention.

In this description “synthetic lumber” means a material that is comprised of natural cellulose containing materials combined with synthetic plastic.

A “composite” means a combination of materials to make up the synthetic lumber such as cellulose and plastic.

The present invention pertains to a process for extruding a decorative synthetic lumber composite 10 (FIG. 3). FIG. 1 schematicly shows an extruding apparatus 12 for producing the decorative synthetic lumber composite 10. The apparatus has a screw 14 with lands 16 in an extruder 30. A plasticized composite melt flows through areas 18 around the screw 14 and through a breaker plate 20. Optionally, screens 22 may be used in front of the breaker plate 20. The melt flows through the breaker plate 20 into area 24 within a mold or die element 28. The screw 14 is retained within extruder 30 which is heated to a temperature as desired. A sensor 32 measures the melt pressure in and around the screw area before the breaker plate 20 while line 31 is a pressure transducer.

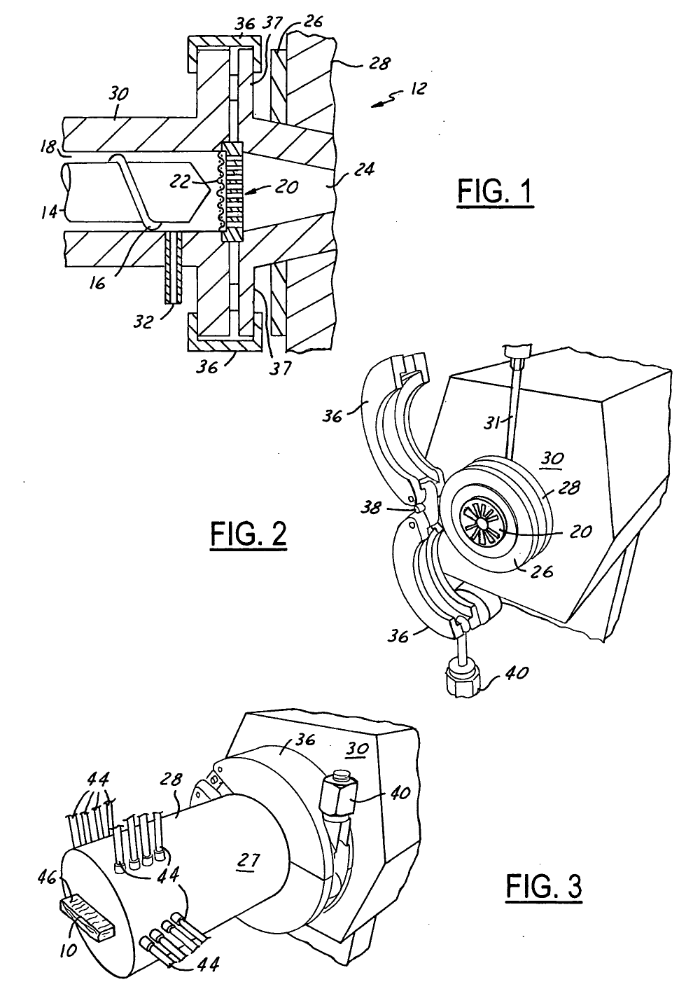

In operation, the die 28, having cooling lines 44, is held in place with extrusion apparatus 30 by a circular locking split collar 36. As can be seen best in FIG. 2 the locking collar halves 36 pivot about pin 38. The locking collar utilizes suitable attaching means 40 for locking the die or mold 28 via extension 37 to a flange 26 of the extrusion apparatus 30.

In order to give a particularly desirable decorative finish to the synthetic lumber product, a pigment is inserted into the feed throat (not shown) of the extruder. In this fashion, preferably at least a portion of the pigment remains at the outer portions 46 of the synthetic lumber extruded product 10.

It is theorized that the pigment, primarily colors the plastic and produces random streaks and variations in color which more realistically simulates natural wood boards and produces pieces of synthetic lumber which when installed adjacent each other have aesthetically pleasing color variations and an appearance much like stained natural wood planks. Regardless of any theoretical explanation, this therefore enhances the decorative properties of the final extruded product.

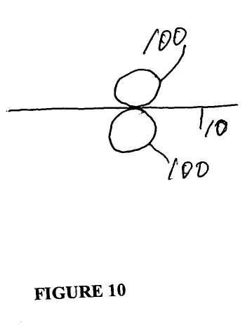

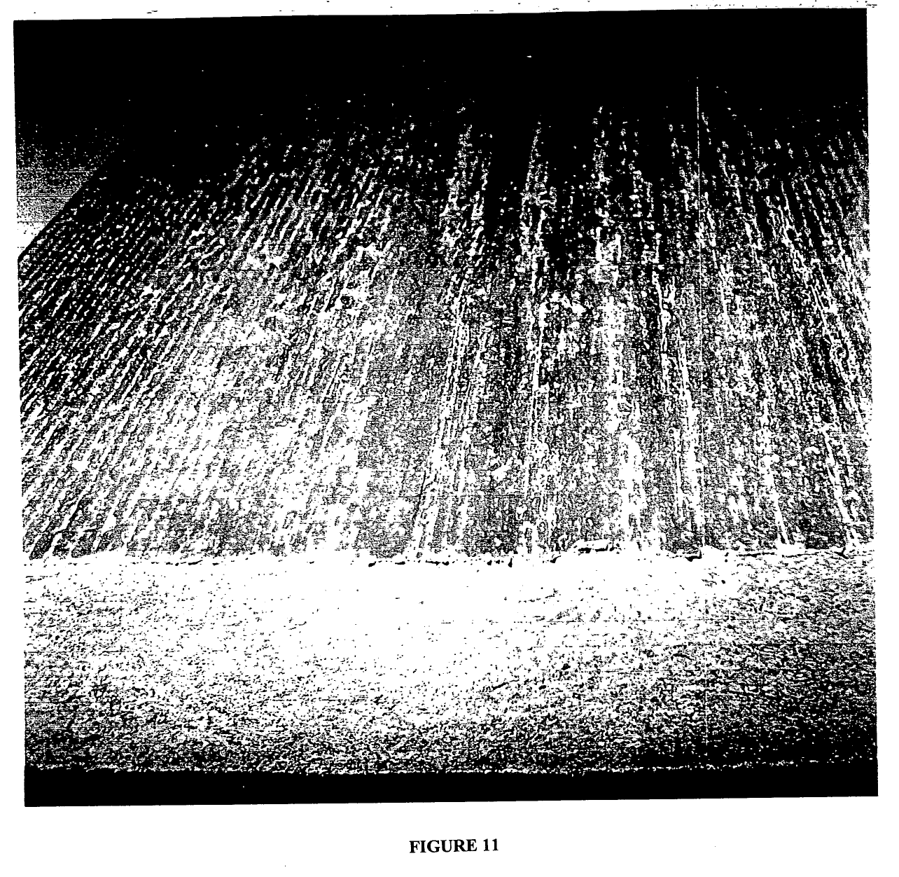

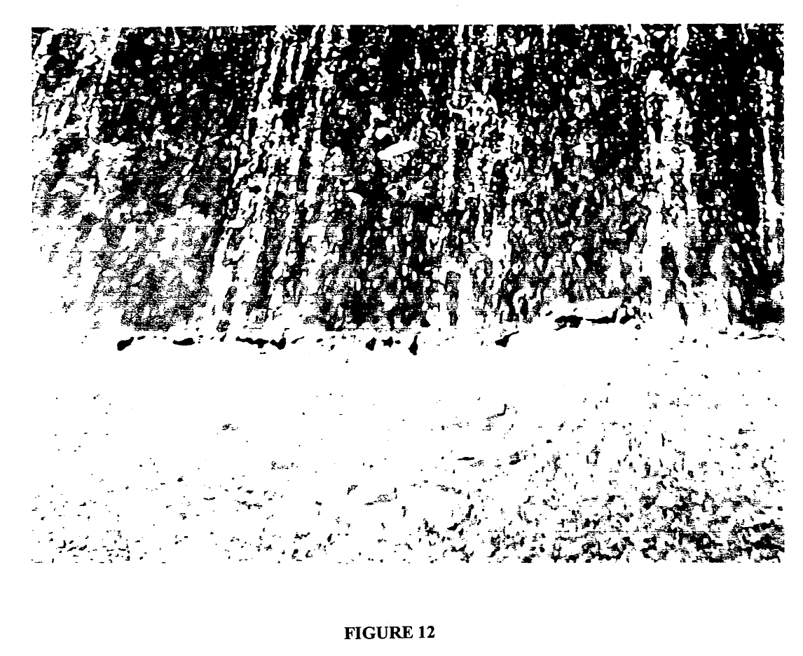

After the product is extruded, preferably it is embossed with a pattern as desired for appropriate wood texture and then cut to length. The embossing creates a raised pattern on the surface of the extruded synthetic lumber. The extruded lumber is cool to the touch and is passed through a pair of embossing wheels 100 which are heated (FIG. 10), such as, at a temperature of 3200 Fahrenheit±15°. The embossing exposes more of the cellulose component of the synthetic lumber. See FIGS. 11 and 12.

A variety of cellulose containing materials can be utilized in the present invention such as sawdust, wood chips, wood fibers, wood particles, ground wood, wood flour, wood flakes, wood veneers, wood laminates, paper, cardboard, straw, cotton, rice hulls, coconut shells, corn cobs, peanut shells, bagasse, plant fibers, bamboo fiber, palm fiber, kenaf, jute, flax, and other suitable conventional cellulosic materials. Other cellulosic materials are described in U.S. Pat. No. 6,780,359, incorporated herein by reference.

With respect to the cellulosic containing materials, preferably a wood flour is utilized of about 40 mesh of a maple wood type.

The plastic that is utilized for the current synthetic lumber product may be a variety of plastics, preferably thermoplastic materials are used. Suitable thermoplastic materials include polyethylene, polypropylene, polyvinylchloride, chlorinated polyvinylchloride, ethylene vinyl acetate, acrylonitirle butadiene styrene (ABS), polystyrene and mixtures thereof and the like. Preferably high density polyethylene (HDPE) is utilized such as that obtained from Dow Chemical Company or Solvey wherein the HDPE has a fractional melt index of 0.7 and a density of 0.95. Thermoset materials may also be utilized such as polyurethanes, phenolic resins, epoxy resins and mixtures thereof and the like. Other plastics that may be utilized are thermoplastic olefins, thermoplastic rubbers, thermoplastic urethanes, styrene block copolymers, polycarbonate and the like.

A wide range of compositions may be utilized for the synthetic lumber. The amount of cellulosic material may range from 20 to 80 percent while the plastic component can range from 80 to 20 percent, desirably about a 50/50 percent and preferably in the range of 40:60 cellulose:plastic to 30:70 cellulose:plastic components.

It is to be appreciated that a variety of materials may be added to the cellulosic plastic composition. Such additional materials may be lubricants and other processing aids as well as fill materials. These materials include inorganic fillers, blowing agents, forming agents, form modifiers, lubricants, stabilizers, accelerators, inhibitors, enhancers, thermosetting agents, processing agents, weathering agents, colorants, UV stabilizers and the like.

A wide variety of processing aids may be utilized. These processing aids are described in Plastics Technology Online from Plastics Technology.com/articles July 2004, herein incorporated by reference. Some materials may be utilized such as Polybond 3029MP, trademark of Crompton Corp. for a maleated high density polyethylene. In addition other maleic anhydrate compositions can be used as additives for strength and long life. A long chain chlorinated paraffin may be utilized as well as zinc stearate or EBS (ethylene bis steramide). Synthetic lumber such as wood plastic composites can use lubricants for the polyolefin such EBS, zinc stearate, paraffin waxes, and oxidized polyethylene. A lubricant package from Struktol, TWP104 (trademark of Struktol) for wood polyolefin composite which contains a zinc stearate may be used.

Colorants for the synthetic lumber composite are likewise used to provide wood like appearance and UV resistance. Other additives may be utilized such as fungicide or preservatives such as zinc boride and the like. Other fungicides and biocides may be utilized as is well known in the art. Stabilizing materials may also be used for wood flour such as quaternary ammonium compound such as Carboquat (trademark of Lonza Corporation). It is to be appreciated that other additives and fillers may be utilized such as talc and the like.

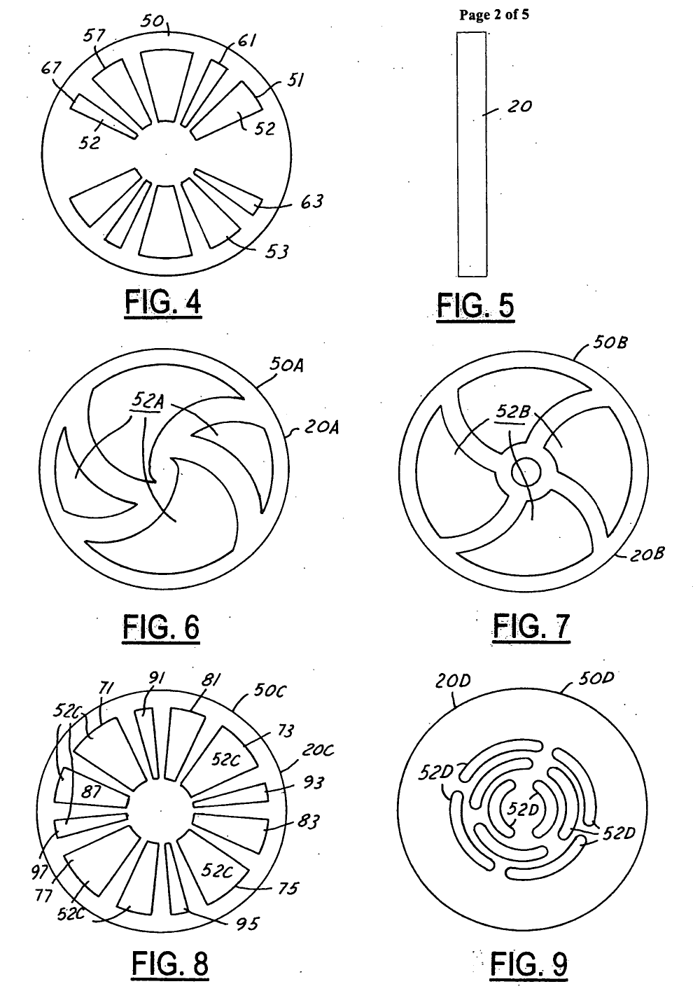

As shown in FIG. 3, typically the breaker plate 20 is retained at the end of the screw extruder. A variety of breaker plates have been utilized in the present invention to facilitate the fabrication of the decorative synthetic lumber product. Alternative breaker plates 20, 20A, 20B, 20C and 20D are shown in FIGS. 4 and 6-9, respectively. FIG. 5 is a side view of the breaker plate of FIG. 4 and the side view of each of the breaker plates of FIGS. 6-9 is the same as FIG. 5. Each breaker plate is generally of a flat metal disk 50, 50A, 50B, 50C and 50D with a series of apertures 52, 52A, 52B, 52C and 52D respectively therethrough.

As shown in FIG. 4 the apertures 52 are trapezoidal in configuration. Breaker plate 20 has on each one-half of the circular breaker plate five trapezoids with the largest trapezoids 54, 56 at 0 degrees and 180 degrees in the circle or at 12 o'clock and 6 o'clock when the face of the breaker plate is considered a twelve hour clock. Intermediate size trapezoids 51, 53, 55 and 57 are respectively at 2 o'clock, 5 o'clock, 8 o'clock and 10 o'clock, when considering the face of circular breaker plate as a clock. The smallest trapezoids 61, 63, 65 and 67 are located at 1 o'clock, 4 o'clock, 7 o'clock and 10 o'clock when the face of the breaker plate is considered a twelve hour clock.

In a similar fashion as shown in FIG. 8, breaker plate 20C has six trapezoids on each half of the circular breaker plate. The largest trapezoids 71, 73, 75 and 77 are equally circumferentially spaced 90 degrees apart around the circular breaker plate. The intermediate sized trapezoids 81, 83, 85, and 87 are next to the large trapezoids and are likewise positioned 90 degrees from each other around the circular breaker plate 50C. The smallest sized trapezoids 91, 93, 95, and 97 are likewise positioned 90 degrees apart from each other around the circular breaker plate. They are positioned between the largest trapezoids and the intermediate sized trapezoid.

The apertures in the breaker plates 50, 50A, 50B, and 50C of FIGS. 4 and 6-8, can be characterized as promoting a swirling effect of the melt as it passes through the breaker plate. Since a majority of the area of the breaker plates 20, 20A, 20B and 20C of FIGS. 4 and 6-8 are in fact open, there is a decrease in the pressure required to facilitate extrusion of the melt through these breaker plates. In a similar fashion FIG. 9 has a series of slots or grooves 52D to facilitate a swirling effect of the melt through the breaker plate.

As shown in FIG. 6, breaker plate 20A has four apertures 52A that are generally triangular in shape with each of the legs of the triangle being arcuate or curved. These apertures 52A are of two different sizes with the larger size aperture diametrically opposed or spaced apart 180 degrees from each other and the smaller size likewise 180 degrees from each other around the circumference of the circular breaker plate.

As shown in FIG. 7, the breaker plate 20B has four apertures 52 B each of which is quadrangular in shape with each leg or edge being curved. These quadrangle apertures 52B of equal size and are approximately equally spaced apart around the circumference of the circular breaker plate 20B. Again the majority of the surface area of the breaker plates 50A and 50B of FIGS. 6 and 7 is open due to the apertures 52A and 52B.

As shown in FIG. 9, the breaker plate 20D has a series of slots or grooves 52D which preferably are disposed in three or more circles each of a different diameter and in each circle are equally spaced symmetrically on the circumference of the breaker plate.

When viewing a face of each of the breaker plates of FIGS. 4-9, it will be appreciated that a substantial amount of area of each breaker plate is apertured with a substantial decrease in blocking of the melt going through the breaker plate. The surface area of each breaker plate can be characterized as being substantially apertured when viewing a side face or from the top thereof.

Typical unrestricted die flow can be characterized as bingham body or plug flow. This flow is then modified through the use of prior art uniform breaker plates. These devices in turn modify portions of the flow. This modification uses the pseudoplastic nature of the material to selectively change portions of the flow. This implies that in areas of high shear, the viscosity of the material is lower. Due to the uniformity of the prior art breaker plates, the shear thinning is uniformly distributed across the profile. A “Bingham plastic” means a non-Newtonian fluid exhibiting a yield stress which must be exceeded before flow starts; thereafter the rate of shear versus shear stress curve is linear. “Shear thinning” implies viscosity decrease of non-Newtonian fluids (for example, complex polymers) that undergo viscosity decreases under conditions of shear stress (that is, viscometric flow).

With a non-uniform breaker plate of the present invention, the shear thinning is non-uniform. This facilitates the direction of the streaks containing the pigment to obtain the decorative synthetic lumber of the present invention.

While FIGS. 1-3 in the present application indicate the general processing of the cellulosic plastic composition utilizing a single extruding phase, it will be appreciated that alternative processing of the cellulosic plastic composition can be utilized. One alternative technique for processing the cellulosic plastic composition would be to use multiple screw extruders. For example a twin screw could be utilized to form pellets of the cellulosic plastic composition. After the pellets are formed, they would be passed to a single screw extruder such as that shown in FIG. 1 or to a multiple screw extruder as part of the extrusion process to form the synthetic lumber product.

In the process of the present invention, a composition that has been found useful is one that contains 60 percent by weight wood flour having a 40 mesh from maple wood. The composition further contains 37 percent high density polyethylene (HDPE) from Dow Chemical Co. having a 0.7 fractional melt index and a density of 0.95. A colorant base, talc addition and TPW-104 (trademark of Struktol) for a processing aid as a lubricant are added, totaling 100 percent by weight.

The mixture of wood flour and HDPE were blended together and fed to an ICMA 128 mm twin screw co-rotating extruder to form pellets of the blended composition. The temperature of the extruder over twelve zones ranged from 400 degrees to approximately 360 degrees Fahrenheit (at the end zone).

The pellets were then fed to a single screw extruder manufactured by Khune Company of Connecticut. The machine has six water cooled zones and four heated temperature zones. The temperature zones increased from approximately 280 degrees to an end temperature of 320 degrees. Colorant was added at the single screw feed. It is believed that the colorant is not mixed throughout the melt but rather streaks or substantially stays at the surface of the extruded synthetic lumber because the single screw extruder does not blend the colorant and the pellets uniformly. See FIG. 11, a photomicrograph, which shows a side portion of a cut synthetic lumber product (Bottom of FIG. 11) and the top surface of the product. (Top of FIG. 11) See also FIG. 12 which is an exploded view of FIG. 11.

Varying colors can be obtained for the decorative synthetic lumber of the present invention. The chart below indicates which pigments are used to obtain the desired final colors of grey, cedar, driftwood, redwood or mahogany. The colorant is manufactured by (ACC) Advanced Color Concepts of Highland, Mich. During the pelletizing part of the process, 1% color is added to the composite mix. This colorant is a paraffin wax (having a melting point of about 1200 Fahrenheit or higher) encapsulated pigment with a letdown ration of 100 to 1 (composite: dye pigment). At the single screw extruder (second extruder), the precolored composite pellet is mixed with an additional 0.3% to 0.4% colorant in the mixing hopper. The chart below shows the percentages by weight.

| | Grey | Cedar | Driftwood | Redwood | Mahogany |
|---|---|---|---|---|---|
| Black | 95.00% | | 0.60% | 3.00% | 3.25% |
| Green | | | | | |
| Dk. Yellow | | 1.20% | | | |
| Dk. Blue | 4.00% | | 1.40% | 1.50% | 75.00% |
| Dk. Green | 1.00% | | | | |
| Steel Grey | | | 98.00% | | |
| Mahogany | | 1.80% | | 95.50% | 94.00% |
| Dk. Brown | | 97.00% | | | 2.00% |

The melt pressure during processing of the cellulose plastic composition as determined from sensor 32, located before the breaker plate, can vary from about 300 psi to about 800 psi (pounds/in² gauge) preferably 400-600 psi. The different breaker plate configurations gave varying processing pressures of the melt. The breaker plate 20 of FIG. 4 had a pressure of about 525 (psi) plus or minus approximately 100 psi. The breaker plate 20A of FIG. 6 had a pressure of approximately 450 psi plus or minus 100 psi. The breaker plate 20B of FIG. 7 had a pressure of approximately 400 psi plus or minus 100 psi. The breaker plate 20C of FIG. 8 had a pressure of approximately 500 psi plus or minus 100 psi. The breaker plate 20D of FIG. 9 had a pressure of approximately 570 psi plus or minus 100 psi.

It is particularly desirable to utilize a low temperature in the extrusion process herein and therefore the temperature at the end zone of the extruder prior to the breaker plate 20 should desirably be less than 360 degrees Fahrenheit and even more preferably less than 320 degrees Fahrenheit when the extrusion rate is about 700-800 pounds/hour of extruded product. This is to be contrasted with the melt temperature and pressure normally used for a wood and polyethylene composition having 62 to 65 percent HDPE which would be an end extruder temperature zone of approximately 400 degrees Fahrenheit and a melt pressure of about 1200 to 1300 psi using commercially available breaker plates and the extruder is operating at about 1000 pounds/hour.

It should be appreciated that while each of the preferred breaker plates of the present invention is one that is static, a moving breaker plate may be alternatively utilized.

It will be appreciated that the breaker plate can be comprised of a wide variety of materials designed to withstand the particular cellulose plastic to be extruded. Such breaker plates can be made of steel, stainless steel, pre-hardened, heat treated, or coated with materials such as titanium oxide, titanium nitride and the like or high corrosion resistant alloys such as Inconel and the like.

While the forms of the invention herein disclosed constitute presently preferred embodiments, many others are possible. It is not intended herein to mention all of the possible equivalent forms or ramifications of the invention. It is understood that the terms used herein are merely descriptive rather than limiting, and that various changes may be made without departing from the spirit or scope of the invention. For example, the breaker plate apertures can have alternative geometric or non-geometric configurations yet still allow low processing melt temperatures and pressures and permit the colorant to be on the exterior surface of the extruded synthetic lumber product.

We claim:

1. A process for extruding a decorative synthetic lumber composite comprising:
providing a cellulose plastic composition;
delivering the composition through an area containing a screw to an extruder;
maintaining a back pressure in the screw area to keep the screw area filled with the composition; and
extruding the composition, at a temperature of at or slightly above the melt point of the composition, into a decorative shaped synthetic lumber product through a breaker plate designed to maintain the back pressure in the screw area.

2. The process of claim 1 wherein prior to the extrusion step, the composition is pellitized and the pellets are fed to the screw extruder.

3. The process of claim 2 wherein a colorant is added to the composition at a feed throat of the extruder so as to allow a portion of the colorant to remain on the surface of the extruded product thereby increasing the decorative properties of the extruded product.

4. The process of claim 1 wherein the composition is melted in the screw area and the flow of the melted composition through the breaker plate is characterized as non uniform shear thinning.

5. The process of claim 1 further comprising adding a colorant to the extruder whereby at least a portion of the colorant is on the surface of the decorative extruded composite.

6. The process of claim 1 wherein the composition is melted and the melt pressure at the breaker plate during processing is about 300 to about 800 psi.

7. The process of claim 1 wherein the composition is melted and the melt pressure at the breaker plate during processing is about 400 to about 600 psi.

8. The process of claim 1 wherein the extruding is performed at a temperature less than about 320 degrees Fahrenheit as set in the last temperature zone in the extruder.

9. The process of claim 1 wherein the plastic is a thermoplastic.

10. The process of claim 9 wherein the thermoplastic is a polyethylene and the cellulose material is wood flour.

11. The process of claim 1 wherein the majority of the surface area of the breaker plate is apertured, and at least some of the apertures are at least one of trapezoids, triangles, quadrangles or slots.

12. The process of claim 1 wherein the temperature of the end zone of the extruder is less than about 360 degrees Fahrenheit.

13. The process of claim 1 further comprising embossing the extruded product.

14. A process for extruding a decorative synthetic lumber composite comprising: providing a cellulose plastic composition; delivering the composition through an area containing a screw to an extruder; maintaining a back pressure in the screw area to keep the screw area filled with the composition; extruding the composition, at a temperature of at or slightly above the melt point of the composition, into a decorative shaped synthetic lumber product through a breaker plate designed to maintain the back pressure in the screw area; and adding a colorant to the composition at feed throat of the extruder so as to allow at least a portion of the colorant to remain on the surface of the extruded product thereby increasing the decorative properties of the extruded product.

15. The process of claim 14 wherein the composition is melted in the screw area and the flow of the melted composition through the breaker plate is characterized non uniform shear thinning.

16. A process for extruding a decorative synthetic lumber composite comprising providing a cellulose plastic composition, delivering the composition through an area containing a screw to a first extruder; extruding pellets of the composition from the extruder; delivering the pellets through a heated area containing a screw to a second extruder; adding a colorant to the composition at the feed throat of the second extruder; maintaining a back pressure in the screw area of the second extruder to keep the screw area filled with the heated composition; and extruding the composition at a temperature at or slightly above the melt point of the composition into a decorative shaped synthetic lumber product through a breaker plate designed to maintain the back pressure in the screw area.

17. A synthetic lumber composite produced according to the process of claim 1.

18. A synthetic lumber composite produced according to the process of claim 14.
